(19) United States
(12) Patent Application Publication
(10) Pub. No.: US 2008/0181718 A1
(43) Pub. Date: Jul. 31, 2008

(54) Installing Processor/Converter Assembly In A Computer

(76) Inventor: Matthew NEUMANN, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/668,426

(22) Filed: Jan. 29, 2007

(51) Int. Cl. F16J 15/52

(52) U.S. Cl. 403/50

(57) ABSTRACT

The present invention provides for installing a processor/converter assembly on a host-system frame of a computer. Clip holes are aligned with slots in a flange of the assembly. The assembly is then mounted on a frame having bolts, so that the bolts extend through the slots and holes. Then the clips are moved relative to the flange and the frame so that the holes are no longer aligned with the slots and bolts and so that the clips are compressed between between bolt shoulders.

### BACKGROUND OF THE INVENTION

To facilitate computer repairs and upgrades, computers are often designed with modular components. One such modular component includes a processor and a voltage converter, both mounted on a carrier structure, e.g., daughterboard. This processor-converter assembly is installed on a motherboard and then secured, e.g., using bolts. The present invention addresses the problem of making the installation of a processor-converter assembly more foolproof. Other features of the invention are apparent from the description below with reference to the following drawings.

Herein, related art is discussed to put the invention in context. Related art labeled “prior art” is admitted prior art; related art not labeled “prior art” is not admitted prior art.

### BRIEF DESCRIPTION OF THE DRAWINGS

The following drawings are of embodiments of the invention and not of the invention itself.

FIG. 1 is a perspective view of a processor-converter assembly installed on a frame in accordance with an embodiment of the invention.

FIG. 2 is a combination schematic view of the processor-converter assembly of FIG. 1 and a method for installing the assembly on a frame in accordance with an embodiment of the invention.

FIG. 3 is a perspective view of a processor-converter assembly and a frame on which it is to be installed accordance with an embodiment of the invention.

FIG. 4 is a detailed elevational cutaway view showing the processor-converter assembly and frame of FIG. 1 in fully installed position.

FIG. 5 is a perspective view of a processor-converter assembly in the processor of being installed on a frame in accordance with an embodiment of the invention

### DETAILED DESCRIPTION

In the course of the invention, it was determined that the method of bolting a processor-converter assembly to a frame had the following problems: a tool was required, loose parts, in this case the bolts, were required, and frame tolerances had to be very tight or the bolting might distort the processor-converter assembly so that the electrical connections between the processor and converter could be interrupted. The present invention addresses all three of these problems.

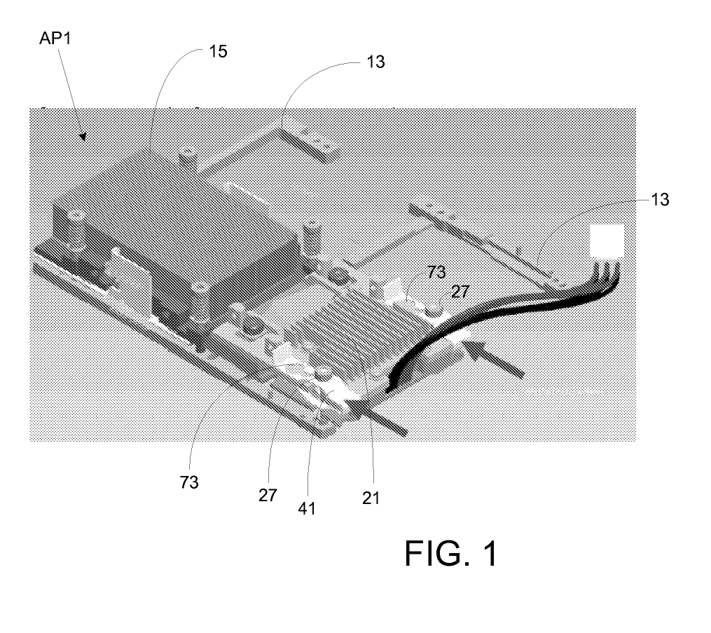

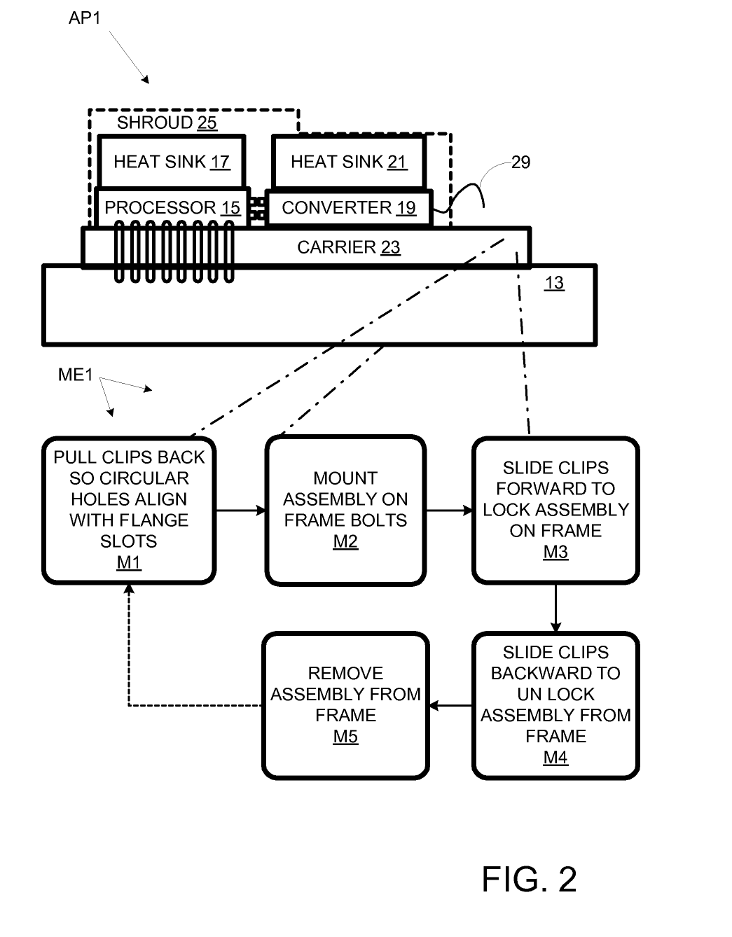

FIG. 1 shows a processor converter assembly AP1 mounted on a frame 13 that itself is fixed as part of a computer system. FIG. 2 shows assembly AP1 separately. As shown in a very schematic FIG. 2, assembly AP1 includes a processor 15, a processor heat sink 17, a voltage converter 19, and a voltage converter head sink 21 all mounted on a carrier 23. A shroud 25 provides extra rigidity to assembly AP1.

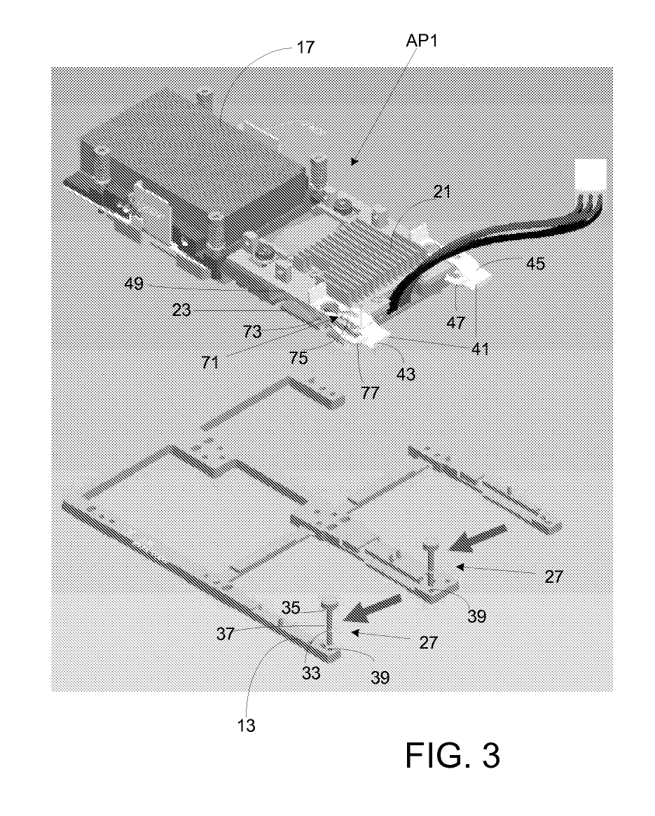

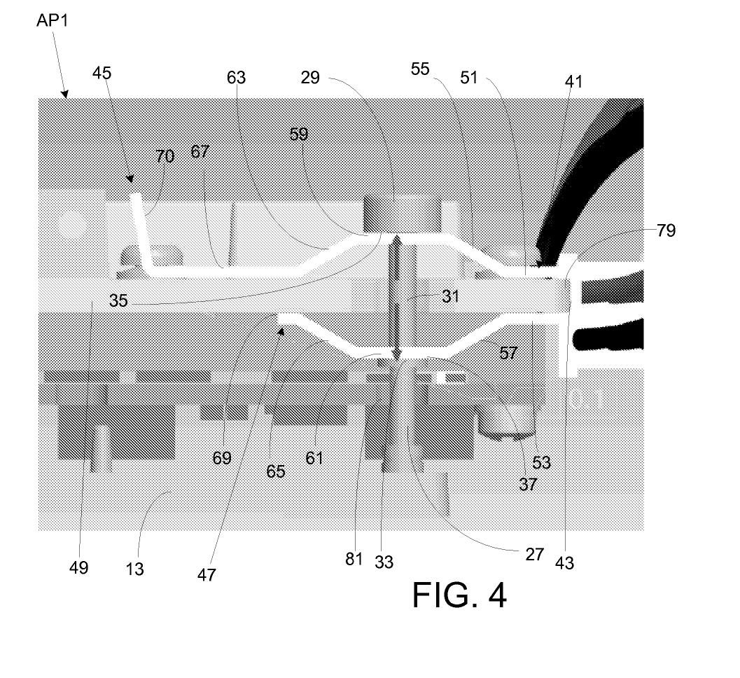

FIG. 3 shows assembly AP1 in position to be mounted on frame 13. Each of a pair of bolts 27 has a head 29, a shaft 31, and a ridge 33. Ridge 33 is located around the shaft 31 about two-third of the length of shaft 31 from the head 29. For each bolt 27, shafts 31 are unthreaded except for the portions shown engaged within frame 13 in FIG. 4. Head 29 and ridge 33 define shoulders 35 and 37, respectively, relative to unthreaded segment of shaft 31. Bolts 27 are permanently attached to frame 13 in that an existing assembly can be removed and replaced without removing bolts 27. Thus, no tools are required to remove or install the bolts, and there are no “loose” bolts involved in replacing a processor-converter assembly.

Clips 41 are strips of sheet metal folded to form a flat end 43 and opposing top and bottom sections 45 and 47 extending therefrom over a flange 49 of converter heat sink 21. As best seen in FIG. 4, each section 45, 47 has a respective first segment 51, 53 that extends at approximately right angles to end 43 to define an open rectangle with end 43. Second clip segments 55 and 57 extend from respective first segments 51 and 53, diverging in opposing directions from flange 49 and from each other. Third segments 59 and 61 extend from second segments 55 and 57 roughly parallel to each other. Fourth segments 63 and 65 extend from the third segments 59 and 61 diagonally toward each other so that they contact respective sides of flange 49. Fifth segments 67 and 69 extend parallel to each other along respective sides of flange 49; bottom fifth section 69 is much shorter than top fifth section 67. A top sixth section 67 diverges sharply from flange 49.

As shown in FIG. 3, upper clip section 45 has a spoon-shaped aperture 71. Spoon-shaped aperture 71 has a circular “spoon-head” section 73 in the fifth section 67 of upper clip section 45. (Note the aperture is best seen in FIG. 3, while the sections are best seen in FIG. 4.) An elongated “spoon handle” section 75 of aperture 71 extends from the circular section 73 across fourth section 63 and into third section 59. Lower clip section 47 has an elongated opening 77 that extends from an end of its short fifth section 69 into third section 61.

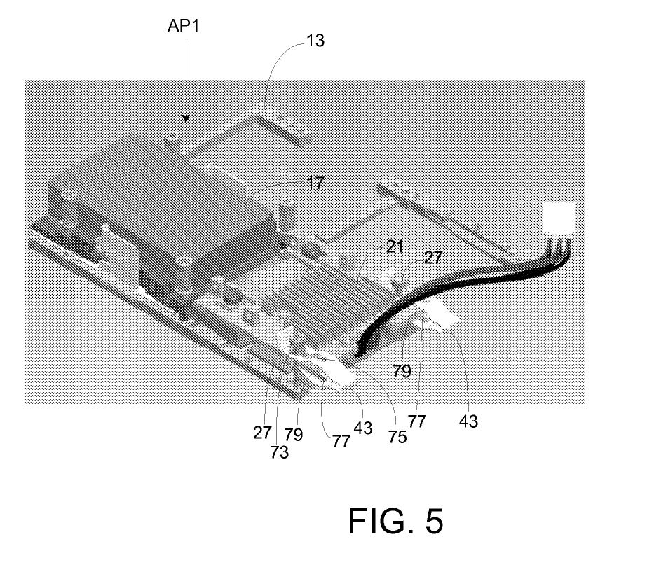

As shipped and prior to installation, clips 41 engage flange 49 so that flat ends 43 contact edge 79 of flange 49. In this position, circular aperture sections 71 do not align with flange slots 81. In preparation for mounting, clips 41 are pulled back so that circular aperture sections 73 align with flange slots 81, so that clip end 43 is spaced from flange edge 79, as in FIG. 5. In this position, the flat ends 43 of clips are spaced from corresponding edge 79 of flange 49. Clips 41 and assembly AP1 are then lowered onto frame 13 so that bolts 27 extend through slots 81 and circular aperture sections 73. The downward travel of assembly AP1 is stopped at the bolt end by the third segment of the bottom section of clips 41. This is the situation depicted in FIG. 5. Once assembly and clips are in a settled position, clip ends 43 are pushed toward flange end 79 until contact. This motion moves the upper section of shaft 31 up elongated aperture section 75 and elongated opening 77, so that upward movement is blocked by shoulder 35 defined by bolt head 29. This is the situation depicted in FIGS. 1 and 4.

With clips 41 in their secure positions, the third segments 59 and 61 are urged toward each other respectively by shoulders 35 and 37. As a result, clips 41 apply counterfources to shoulders 35 and 37, flexibly suspending flange 49 between shoulders 35 and 37, as shown in FIG. 4. The counter forces flexibly support the converter end of assembly AP1; thus, reducing tension between converter 19 and processor 15 relative to an arrangement where the converter end of an assembly is rigidly bolted down, or even attached using single-sided clips.

FIG. 2 includes a flow chart of a method ME1 used to install assembly AP1 on frame 13. At method segment M1, clips 41 are pulled back so that circular aperture sections 73 align with flange slots 81. At method segment M2, assembly 41 is mounted on frame 13 so that bolts 47 extend through flange slots 81 and circular aperture sections 73. At method segment M3, clips 41 are moved forward so that circular aperture sections 73 are no longer aligned with flange slots 81, thus locking assembly AP1 onto flange 49.

To replace assembly AP1, clips 41 are slid backwards, at method segment M4. This aligns circular aperture sections 73 with bolts 27 and flange slots 81. Then assembly AP1 is lifted and removed from frame 13 at method segment M5. From this point, method ME1 can be iterated, presumably with a new processor-converter assembly.

Note that no tool is required to install processor/converter assembly on frame 13. (However, it may still be desirable to bolt the processor as shown in FIG. 4 once the assembly is installed). Also, assuming the bolts are pre-installed, there are no separate parts (e.g., loose bolts) to manage to effect installation. Also, the double spring action relaxes tolerances in both up and down directions. In an alternative processor, the clips and flange have additional features to make it difficult to remove the clips from the flange inadvertently. In another embodiment, grooves in the flange ensure clip motion is laterally constrained for more precise alignment. These and other variations upon and modifications to the disclosed embodiments are provided for by the present invention, the scope of which is defined by the following claims.

What is claimed is:

1. A method of installing a processor/converter assembly on a host-system frame of a computer, said method comprising:
aligning clip holes with a slots in a processor/converter assembly flange;
mounting said assembly on a frame so that bolts attached to said frame extend through said slots and said clip holes; and
moving said clips relative to said bolts and said slots so that said clips are compressed by opposing shoulders of each of said bolts.

2. A method as recited in claim 1 further comprising: moving said clips to align said clip holes with said bolts; and removing said assembly from said frame.

3. A method as recited in claim 1 wherein said clip hole is a circular section of an aperture also contain an elongated section that engages said bolt when said clips are compressed.

4. A processor-converter assembly comprising:
a processor;
a converter;
a flange with slots; and
clips with apertures having relatively round sections and relatively elongated sections, said clips being movable relative to said flange so that said slots can selectively align either with said relative round sections and said relatively elongated sections.

5. An assembly as recited in claim 4 further comprising a heat sink mounted on said converter, said flange being part of said heat sink.

6. An assembly as recited in claim 4 wherein each of said clips contact said flange on at least two sides.

7. An assembly as recited in claim 4, wherein, when one of said clips contacts said flange on three sides, its round aperture section is not aligned with a respective slot.
